(19) United States
(12) Patent Application Publication
(10) Pub. No.: US 2016/0168332 A1
(43) Pub. Date: Jun. 16, 2016

(54) Chemical processing article

(71) Applicant: SOLVAY SPECIALTY POLYMERS USA, LLC, Alpharetta, GA (US)

(72) Inventors: David B. THOMAS, Atlanta, GA (US); Chantal LOUIS, Alpharetta, GA (US); Mohammad Jamal EL-HIBRI, Atlanta, GA (US)

(73) Assignee: SOLVAY SPECIALTY POLYMERS USA, LLC, Alpharetta, GA (US)

(21) Appl. No.: 14/906,171

(22) PCT Filed: Jul. 16, 2014
(86) PCT No.: PCT/EP2014/065307

§ 371 Date: Jan. 19, 2016

Related U.S. Application Data
(60) Provisional application No. 61/857,046, filed on Jul. 22, 2013.

(30) Foreign Application Priority Data
Sep. 19, 2013 (EP) 13185210.5

(51) Int. Cl. C08G 75/23; B29C 45/00; B05D 1/26; C08L 81/06

(52) U.S. Cl. CPC C08G 75/23; C08L 81/06; B29C 45/0001; B05D 1/265; B29K 2081/06

(57) ABSTRACT

A chemical processing article comprising at least one part made of a poly(arylether sulfone) polymeric material comprising at least one poly(arylether sulfone) polymer, wherein said (t-PAES) polymer comprising more than 50% moles of recurring units (Rₜ) of formula (Sₜ): -E-Ar¹—SO₂—[Ar²-(T-Ar³)n-SO₂]ₘ—Ar⁴ wherein n and m, equal to or different from each other, are independently zero or an integer of 1 to 5, each of Ar¹, Ar², Ar³ and Ar⁴ equal to or different from each other and at each occurrence, is an aromatic moiety, T is a bond or a divalent group and E is of formula (Eₜ) wherein each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; j′ is zero or is an integer from 1 to 4.

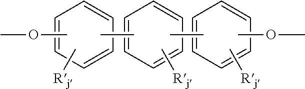

### CROSS-REFERENCE TO RELATED APPLICATION

This application claims priority to U.S. provisional application No. 61/857,046 filed Jul. 22, 2013, and to European application No. 13185210.5 filed Sep. 19, 2013, the whole content of these applications being incorporated herein by reference for all purposes.

### FIELD OF INVENTION

The present invention is related to an article suitable for use in chemical process industries comprising polyarylene ether sulfone (PAES) polymer based materials, wherein said (PAES) polymers comprise moieties derived from incorporation of 4,4″-terphenyl-p-diol. Said (PAES) polymer based material is characterized by having improved mechanical properties, in particular having an excellent balance of stiffness and ductility, good chemical resistance, high thermal resistance (e.g. Tg>230° C.), long term thermal stability, useful highest Tm between 360° C. and 420° C.

### BACKGROUND OF THE INVENTION

The Chemical Processing Industry [CPI, herein after] is a remarkable group of companies carrying out rather diverse manufacturing activities producing a wide range of product. These products vary from high-purity gases to organic liquids, various acids, agricultural chemicals, plastics, and a host of related materials. The operations required to carry out these manufacturing activities are as varied as the products they produce. However, as an industry, there are several common characteristics that many of these operations share. These include inter-alia operations at high pressures, such as ammonia synthesis, operations at high temperatures, such as notably ethylene production, handling corrosive materials including acids and bases, such as ammonia oxidation, exothermic chemical reactions, such as notably ammonium nitrate production, that have the potential to run away into an explosion, and handling large volumes of hazardous materials.

The chemical processing industry also strives for purity of product. The contamination introduced by materials used to handle the substances during production is also a selection criteria.

It is a critical challenge for the CPI in the development of chemical processing articles including polymeric materials that said articles can resist these extreme conditions of being exposed in a prolonged fashion to high pressure, e.g. pressures higher than 30,000 psi, high temperatures e.g. temperatures up to 260° C. to 300° C. and to harsh chemicals including acids, bases, superheated water/steam, oxidizers and solvents, in particular organic solvents.

In this light, the selection of polymeric material is of ultimate importance as it implies that said polymeric materials need to possess some critical properties in order to resist the extreme conditions associated with the above mentioned severe operating conditions of high temperature, high pressure, harsh chemicals and other extreme conditions.

In the chemical processing industry, the polyetheretherketone (PEEK) polymer is often chosen as polymeric material because it is inherently pure, and has outstanding chemical resistance and high temperature resistance properties.

However, chemical processing articles made from semi-crystalline PEEK polymers no longer resist pressures up to 30,000 psi and temperatures up to 300° C. and have the drawbacks that said articles can not be used any more in CPI manufacturing activities requiring the above mentioned severe operating conditions of high temperature, high pressure, harsh chemicals and other extreme conditions.

As mentioned above, polymeric materials useful for providing articles suitable for use in said CPI manufacturing activities should thus possess properties such as maintaining or improved mechanical rigidity and integrity (e.g. yield/tensile strength, hardness and impact toughness) at high pressure and temperatures of at least 260° C., good chemical resistance, in particular to harsh chemicals at said high pressure and temperature.

Thus, there remains a continuous need for articles suitable for use in CPI applications comprising at least one polymeric material that can overcome the drawbacks, mentioned above, and wherein said polymeric material features excellent mechanical properties (and in particular good combination of high stiffness and ductility), having an excellent balance of stiffness and ductility, good processability, high chemical resistance, high thermal resistance (e.g. Tg>260° C.) and long term thermal stability, and wherein said polymeric material provide final articles having all these improved properties, as mentioned above.

### SUMMARY OF INVENTION

The present invention addresses the above detailed needs and relates to chemical processing article, as well as a method of processing chemicals including the use of the same, comprising at least one part made of a poly(arylether sulfone) polymeric material [(t-PAES) polymeric material, herein after] comprising at least one poly(arylether sulfone) polymer [(t-PAES) polymer], wherein said (t-PAES) polymer comprising more than 50% moles of recurring units (Rₜ) of formula (Sₜ):

-E-Ar¹—SO₂—[Ar²-(T-Ar³)ₙ—SO₂]ₘ—Ar⁴— (formula Sₜ)

wherein:
n and m, equal to or different from each other, are independently zero or an integer of 1 to 5,
each of Ar¹, Ar², Ar³ and Ar⁴ equal to or different from each other and at each occurrence, is an aromatic moiety,
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

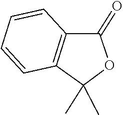

E is of formula (Eₜ):

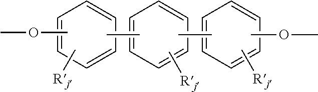

wherein each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; j′ is zero or is an integer from 1 to 4.

### BRIEF DESCRIPTION OF THE DRAWING

FIG. 1 depicts the pressure and temperature profile curve obtained in rapid in Rapid Gas Decompression Test.

### THE CHEMICAL PROCESSING ARTICLE

To the purposes of the invention, the term “chemical processing article” is intended to denote any article that is designed to conveniently be used in CPI applications, in particular in severe operating conditions of high temperature, high pressure and harsh chemicals.

For the sake of clarity, the term “part of chemical processing article” is intended to denote a piece or portion which is combined with others to make up the whole chemical processing article. The external coating of chemical processing article falls thus within this scope. Thus, the at least one part of chemical processing article according to the present invention, can be a coating.

Representative examples of CPI applications, but not limited to, include air pollution controls, industrial water solution treatments, specialty gas separation applications, high temperature gas filtration applications, gas and fluid transport applications, including transfer, storage, tank car loading/unloading, compressed air applications, and the like.

All these applications as herein mentioned above, are well familiar to the skilled person, and should be understood under their common meaning.

A chemical processing system is generally assembled into a complex system with a large number of valving connections between individual elements with varying functions and attributes.

As non limitative examples of chemical processing articles useful in the present invention are air separation systems; as notably described in U.S. Pat. No. 5,076,837 A1, the entire disclosure of which is incorporated herein by reference; compressor systems, such as notably air and gas, reciprocating and liquid ring compressors; chemical processing pumping systems; motor systems, sensors, such as reservoir sensors; control systems, such as temperature, pressure; odour, air pollution, electrical and process control systems; agitator systems; centrifuge systems; chillers; columns including notably adsorption, autoclave, clean-up, distillation, extraction, recycle, rectifying, separation columns; reactors, including notably agitated, autoclave, fluidized bed, gas phase, heated, kettles, loop, polymer, tubed, reactors; condensers; converters; coolers; crystallizers; dryers such as notably kiln and rotary dryers; evaporators; extruders; conveyors; heat exchangers; fractionators; furnaces; heater; melt tanks, vessels such as notably chemical reaction vessels, mixing and blending vessels; precipitators; reboilers; reformers; refrigeration systems; saturators; scrubbers; silos; towers; waste heat boilers, piping systems; valve systems; tubing systems; and others.

All these systems as herein mentioned above, are well familiar to the skilled person, and should be understood under their common meaning.

As non limitative examples of chemical processing pumping systems useful in the present invention are vacuum pumps, such as notably rotary vacuum pumps as notably described in U.S. Pat. No. 4,781,553 A1 the entire disclosure of which is incorporated herein by reference, centrifugal pumps, irrigation pumps and the like.

It is generally known that chemical processing pumping systems in particular are exposed to corrosion attack from hazardous liquids.

As non limitative examples of motor systems useful in the present invention are a submersible motor chemical processing apparatus, as notably described in U.S. Pat. No. 4,325,394 A1, the entire disclosure of which is incorporated herein by reference.

As non limitative examples of pipe systems useful in the present invention, mention can be made of pipes including rigid pipes and flexible pipes, flexible risers, jumpers, pipe-in-pipe, pipe liners, spools.

Typical flexible pipes have been described by way of example in WO 2010/046672 A1 and U.S. Pat. No. 2011/0168288 the entire disclosure of those are incorporated herein by reference. Such flexible pipes can notably be used for the transport of fluids where very high or very different water pressure prevails over the length of the pipe, or for example be used as pipes for the transport of liquids or gases between various items of equipment, including chemical processing equipment, or as pipes laid at great depth on the ocean floor, or as pipes between items of equipment close to the ocean surface, and the like.

Preferred pipe systems are pipes, flexible risers and pipe liners.

By the term “valves” is meant any device for halting or controlling the flow of a liquid, gas, or any other material through a passage, pipe, inlet, outlet, and the like. As non limitative examples of valve systems useful in the present invention, mention can especially be made of choke valves, thermal expansion valves, check valves, ball valve, butterfly valve, diaphragm valve, gate valve, globe valve, knife valve, needle valve, pinch valve, piston valve, plug valve, poppet valve, spool valve, pressure reducing valve, sampling valves, safety valve.

The at least one part of the chemical processing articles according to the present invention may be selected from a large list of articles such as fitting parts; such as seals, in particular sealing rings, fasteners and the like; snap fit parts; mutually movable parts; functional elements, operating elements; tracking elements; adjustment elements; carrier elements; frame elements; films; switches; bearings, connectors; wires, cables; housings, and any other structural part other than housings as used in chemical processing articles, such as for example shafts, plates.

In particular, the (t-PAES) polymeric material is very well suited for the production of seals, fasteners, cables, electrical connectors, agitator parts, vessels, housing parts of chemical processing articles, in particular instrument housings.

In one preferred embodiment, the at least one part of the chemical processing article according to the present invention, is advantageously a chemical processing housing, a seal, a fastener, an electrical connector, or a cable.

A cable can be notably wires electrically connecting the different parts within a chemical processing article, for example connecting different electrical connectors, connecting tools to connectors, instruments or other tools, connecting instruments to connectors, other instruments or tools, connecting a power source to connectors, instruments or tools. A cable can also advantageously be used for carrying a signal to computer systems.

In a particularly aspect of this preferred embodiment, the cable is a coated wire or a wire coating.

In another particular aspect of this preferred embodiment, the cable can further include a jacket material.

By “chemical processing housing” is meant one or more of the back cover, front cover, frame and/or backbone of a chemical processing article. The housing may be a single article or comprise two or more components. By “backbone” is meant a structural component onto which other components of the chemical processing article, are mounted. For example, the backbone could be attached to instruments, an impeller, a shaft such as notably in an agitator and also can support seals. The backbone may be an interior component that is not visible or only partially visible from the exterior of the chemical processing article.

An example of a chemical processing housing has been described notably in WO 2004/045258 A2, the entire disclosure of those are incorporated herein by reference.

Typical fasteners have been described by way of example in WO 2010/112435, the entire disclosure of those are incorporated herein by reference, and include, but not limited to, threaded fasteners such as bolts, nuts, screws, headless set screws, scrivets, threaded studs and threaded bushings, and unthreaded fastener, such as notably pins, retaining rings, rivets, brackets and fastening washers and the like.

Sealing of components of chemical processing articles is important and it can be said that seals are used in all types of chemical processing articles, as well as those used in parts of chemical processing articles. As non limitative examples of components that need to be sealed, mention can notably be made of pumps, agitators, compressors; fittings, flanges, pipes and ducts carrying gases and liquids.

Thus the seals need to resist to these extreme conditions, as mentioned above, and that in substantially indefinite time. It is worthwhile mentioning that seals besides electronics can be considered as the most vulnerable parts of chemical processing articles.

In one embodiment of the present invention, the at least part of chemical processing article is a seal wherein said seal is selected from a group consisting of a metal seal, an elastomeric seal, a metal-to-metal seal and an elastomeric and metal-to-metal seal.

Representative examples of seals, but not limited to, include seal rings such as notably C-rings, E-rings, O-rings, U-rings, spring energized C-rings, backup rings and the like; fastener seals; piston seals, gask-O-seals; integral seals, labyrinth seals.

In a particularly preferred embodiment, the at least one part of the chemical processing article according to the present invention, is a seal ring, preferably a backup seal ring.

The weight of the (t-PAES) polymeric material, based on the total weight of chemical processing article, is usually above 1%, above 5%, above 10%, preferably above 15%, above 20%, above 30%, above 40%, above 50%, above 60%, above 70%, above 80%, above 90%, above 95%, above 99%.

The chemical processing article may consist of one part, i.e. it is a single-component article. Then, the single part preferably consists of the (t-PAES) polymeric material.

Alternatively, the chemical processing article may consist of several parts. The case being, either one part or several parts of the chemical processing article may consist of the (t-PAES) polymeric material. When several parts of the chemical processing article consist of the (t-PAES) polymeric material, each of them may consist of the very same the (-PAES) polymeric material; alternatively, at least two of them may consist of different the (t-PAES) polymeric material, in accordance with the invention.

### The Method of Processing Chemicals

As explained above, in another aspect, the invention pertains to a method of processing at least one chemical, using at least one chemical processing article, as above detailed.

In particular, the method of the present invention can be notably selected from the group consisting of:
(i) a method for controlling air pollution,
(ii) a method for the treatment of industrial water solutions,
(iii) a method for the separation of at least one gas,
(iv) a method for the filtration of at least one gas;
(v) a method for transporting at least one fluid;
(vi) a method of compressing at least one fluid;
(vii) a method of reacting at least one chemical;
(viii) a method of heating or cooling at least one chemical.

Any of the chemical processing articles, as described above, comprising at least one part comprising the (t-PAES) polymeric material as above defined can be used in the methods above detailed.

The (t-PAES) Polymer

The aromatic moiety in each of Ar¹, Ar², Ar³ and Ar⁴ equal to or different from each other and at each occurrence is preferably complying with following formulae:

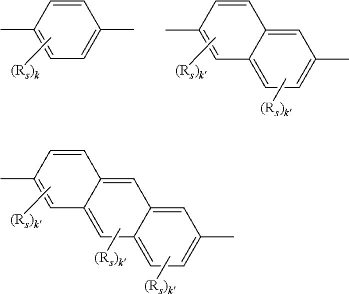

wherein:
each Rₛ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
k is zero or an integer of 1 to 4; k′ is zero or an integer of 1 to 3.

In recurring unit (Rₜ), the respective phenylene moieties may independently have 1,2-, 1,4- or 1,3-linkages to the other moieties different from R or R′ in the recurring unit. Preferably, said phenylene moieties have 1,3- or 1,4-linkages, more preferably they have 1,4-linkage.

Still, in recurring units (Rₜ), j′, k′ and k are at each occurrence zero, that is to say that the phenylene moieties have no other substituents than those enabling linkage in the main chain of the polymer.

Preferred recurring units (Rₜ) are selected from the group consisting of those of formula (Sₜ-1) to (Sₜ-4) herein below:

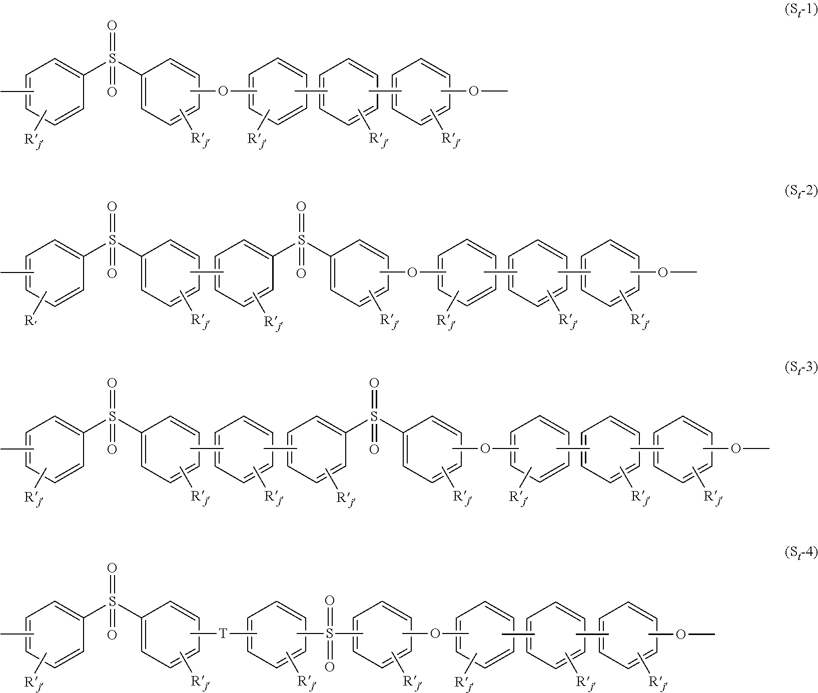

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4,
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

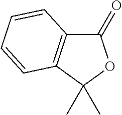

The above recurring units of preferred embodiments (Rₜ-1) to (Rₜ-4) can be each present alone or in admixture.

More preferred recurring units (Rₜ) are selected from the group consisting of those of formula (S′ₜ-1) to (S′ₜ-3) herein below:

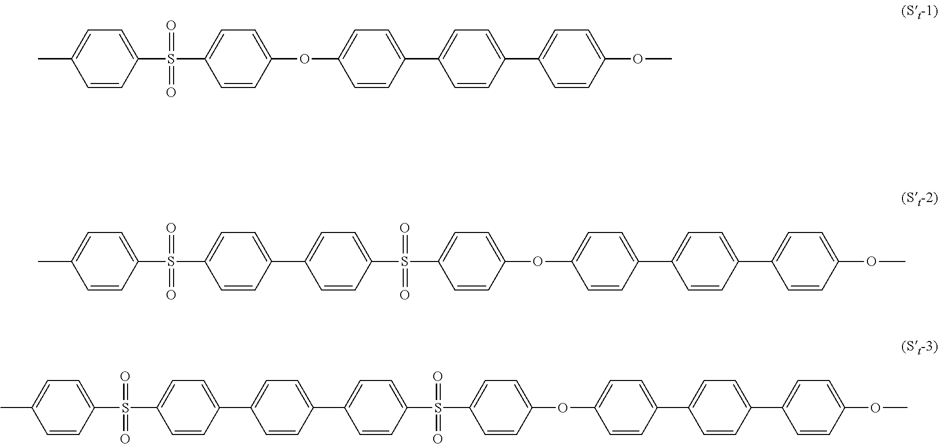

Most preferred recurring unit (Rₜ) is of formula (S′ₜ-1), as shown above. According to certain embodiments, the (t-PAES) polymer, as detailed above, comprises in addition to recurring units (Rₜ), as detailed above, recurring units (Rₐ) of formula (Kₐ):

-E-Ar⁵—CO—[Ar⁶-(T-Ar⁷)ₙ—CO]ₘ—Ar⁸— (formula Kₐ)

wherein:
n and m, equal to or different from each other, are independently zero or an integer of 1 to 5,
each of Ar⁵, Ar⁶, Ar⁷ and Ar⁸ equal to or different from each other and at each occurrence, is an aromatic moiety,
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

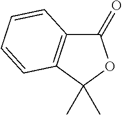

E is of formula (Eₜ), as detailed above.

Recurring units (Rₐ) can notably be selected from the group consisting of those of formulae (Kₐ-1) or (Kₐ-2) herein below:

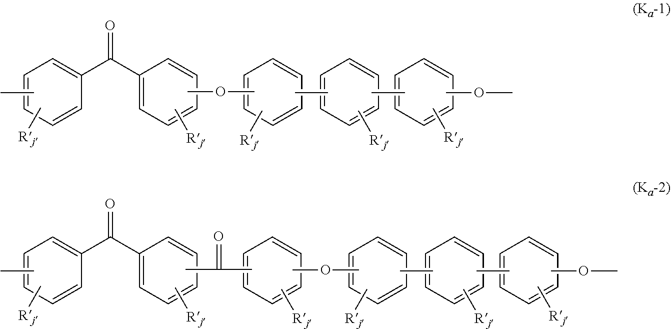

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4.

More preferred recurring units (Rₐ) are selected from the group consisting of those of formula (K′ₐ-1) or (K′ₐ-2) herein below:

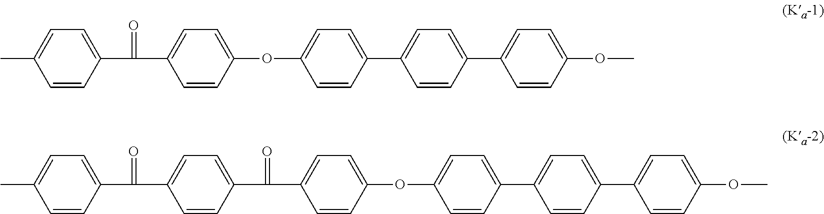

According to certain embodiments, the (t-PAES) polymer, as detailed above, comprises in addition to recurring units (Rₜ), as detailed above, recurring units (R_{b}) comprising a Ar—SO₂—Ar′ group, with Ar and Ar′, equal to or different from each other, being aromatic groups, said recurring units (R_{b}) generally complying with formulae (S1):

—Ar⁹-(T′-Ar¹⁰)ₙ—O—Ar¹¹—SO₂—[Ar¹²-(T-Ar¹³)ₙ—SO₂]ₘ—Ar¹⁴—O— (S1)

wherein:
Ar⁹, Ar¹⁰, Ar¹¹, Ar¹², Ar¹³ and Ar¹⁴, equal to or different from each other and at each occurrence, are independently a aromatic mono- or polynuclear group;
   T and T′, equal to or different from each other and at each occurrence, is independently a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

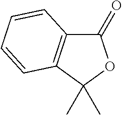

preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

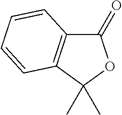

n and m, equal to or different from each other, are independently zero or an integer of 1 to 5;

Recurring units (R_{b}) can be notably selected from the group consisting of those of formulae (S1-A) to (S1-D) herein below:

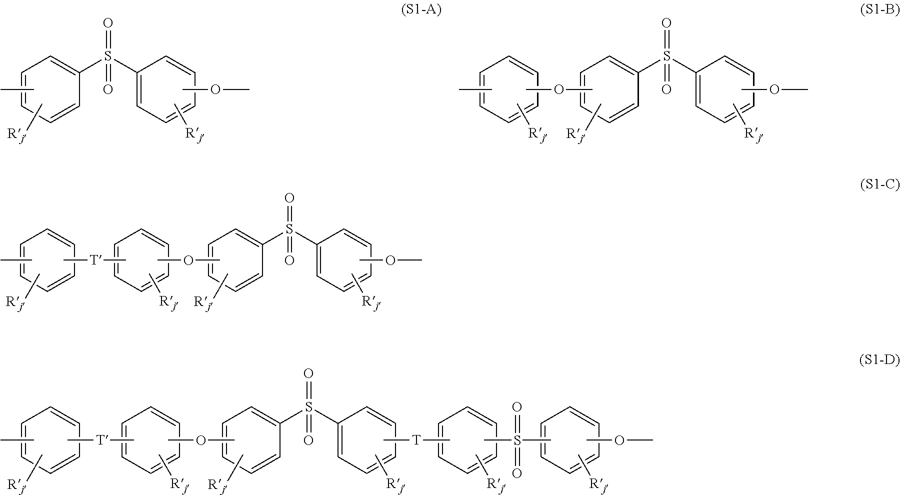

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4;
T and T′, equal to or different from each other are a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

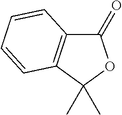

preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

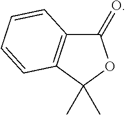

In recurring unit (R_{b}), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage. Still, in recurring units (R_{b}), j′ is at each occurrence zero, that is to say that the phenylene moieties have no other substituents than those enabling linkage in the main chain of the polymer.

According to certain embodiments, the (t-PAES) polymer, as detailed above, comprises in addition to recurring units (Rₜ), as detailed above, recurring units (R_{c}) comprising a Ar—C(O)—Ar′ group, with Ar and Ar′, equal to or different from each other, being aromatic groups, said recurring units (R_{c}) being generally selected from the group consisting of formulae (J-A) to (J-L), herein below:

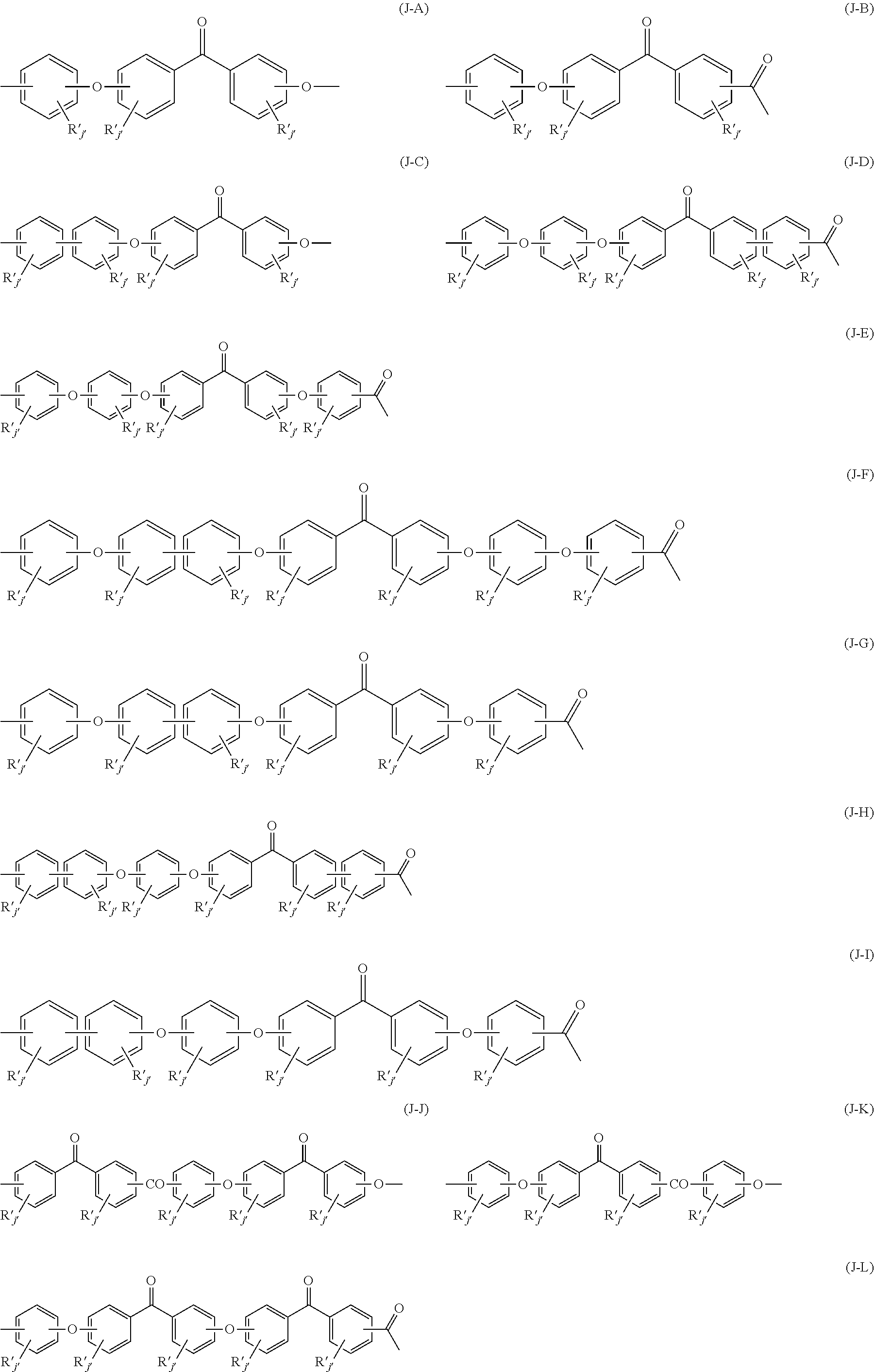

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4.

In recurring unit (R_{c}), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage.

Still, in recurring units (R_{c}), j′ is at each occurrence zero, that is to say that the phenylene moieties have no other substituents than those enabling linkage in the main chain of the polymer.

As said, the (t-PAES) polymer comprises recurring units (Rₜ) of formula (Sₜ) as above detailed in an amount of more than 50% moles, preferably more than 60% moles, more preferably more than 70% moles, even more preferably more than 80% moles, most preferably more than 90% moles, the complement to 100% moles being generally recurring units (Rₐ), as above detailed, and/or recurring units (R_{b}), and/or recurring units (R_{c}), as above detailed.

Still more preferably, essentially all the recurring units of the (t-PAES) polymer are recurring units (Rₜ), chain defects, or very minor amounts of other units might be present, being understood that these latter do not substantially modify the properties of the (t-PAES) polymer. Most preferably, all the recurring units of the (t-PAES) polymer are recurring units (Rₜ). Excellent results were obtained when the (t-PAES) polymer was a polymer of which all the recurring units are recurring units (Rₜ), as above detailed.

To the aim of providing polymers particularly suitable for being used in chemical processing articles, the (t-PAES) polymer of the invention has advantageously a number average molecular weight (Mₙ) of at least 13 000, preferably at least 25 000, more preferably of at least 38 000.

Upper limit for the number average molecular weight (Mₙ) of the (t-PAES) polymer is not particularly critical and will be selected by the skilled in the art in view of final field of use.

In one embodiment of the present invention, the t-PAES polymer has advantageously a number average molecular weight (Mₙ) equal to or below 125 000, preferably equal to or below 95 000, preferably equal to or below 90 000, preferably equal to or below 80 000, preferably equal to or below 75 000, preferably equal to or below 70 000, preferably equal to or below 60 000, preferably equal to or below 56 000.

In one embodiment of the present invention, the t-PAES polymer has advantageously a number average molecular weight (Mₙ) in the range from 13 000 to 125 000, preferably ranging from 25 000 to 80 000, and preferably ranging from 38 000 to 80 000.

The (t-PAES) polymer having such specific molecular weight (Mₙ) range have been found to possess an excellent ductility (i.e high tensile elongation), good thoughness while maintaining high Tg, and good crystallizability and good chemical resistance.

The expression “number average molecular weight (Mₙ)” is hereby used according to it usual meaning and mathematically expressed as:

$${M}_{n} = \frac{\sum {M}_{i} \cdot {N}_{i}}{\sum {N}_{i}}$$

wherein Mᵢ is the discrete value for the molecular weight of a polymer molecule, Nᵢ is the number of polymer molecules with molecular weight then the weight of all polymer molecules is ΣMᵢNᵢ and the total number of polymer molecules is ΣNᵢ.

Mₙ can be suitably determined by gel-permeation chromatography (GPC), calibrated with polystyrene standards.

Other molecular parameters which can be notably determined by GPC are the weight average molecular weight (M_{w}):

$${M}_{w} = \frac{\sum {M}_{i}^{2} \cdot {N}_{i}}{\sum {M}_{i} \cdot {N}_{i}} ,$$

wherein Mᵢ is the discrete value for the molecular weight of a polymer molecule, Nᵢ is the number of polymer molecules with molecular weight then the weight of polymer molecules having a molecular weight Mᵢ is MᵢNᵢ.

For the purpose of the present invention, the polydispersity index (PDI) is hereby expressed as the ratio of weight average molecular weight (M_{w}) to number average molecular weight (Mₙ).

The details of the GPC measurement are described in detail in the method description given in the experimental section and notably described in our copending U.S. Provisional Patent Application.

The (t-PAES) polymer of the present invention has advantageously a polydispersity index (PDI) of more than 1.90, preferably more than 1.95, more preferably more than 2.00.

The (t-PAES) polymer of the present invention generally has a polydispersity index of less than 4.0, preferably of less than 3.8, more preferably of less than 3.5.

In addition, some other analytical methods can be used as an indirect method for the determination of molecular weight including notably viscosity measurements.

In addition, some other analytical methods can be used as an indirect method for the determination of molecular weight including notably viscosity measurements.

In one embodiment of the present invention, the (t-PAES) polymer of the present invention has a melt viscosity of advantageously at least 0.7 kPa·s, preferably at least 1.25 kPa·s, more preferably at least 2.3 kPa·s at 410° C. and at a shear rate of 10 rad/sec, as measured using a parallel plates viscometer (e.g. TA ARES RDA3 model) in accordance with ASTM D4440. The (t-PAES) polymer of the present invention has a melt viscosity of advantageously of at most 46 kPa·s, preferably of at most 34 kPa·s, more preferably of at most 25 kPa·s at 410° C. and at a shear rate of 10 rad/sec, as measured using a parallel plates viscometer (e.g. TA ARES RDA3 model) in accordance with ASTM D4440.

In another embodiment of the present invention, the (t-PAES) polymer of the present invention has a melt viscosity of advantageously at least 2.2 kPa·s, preferably at least 4.1 kPa·s, more preferably at least 7.4 kPa·s at 410° C. and at a shear rate of 1 rad/sec, as measured using a parallel plates viscometer e.g. (TA ARES RDA3 model) in accordance with ASTM D4440. The (t-PAES) polymer of the present invention has a melt viscosity of advantageously of at most 149 kPa·s, preferably of at most 111 kPa·s, more preferably of at most 82 kPa·s at 410° C. and at a shear rate of 1 rad/sec, as measured using a parallel plates viscometer (e.g. TA ARES RDA3 model) in accordance with ASTM D4440.

The (t-PAES) polymer of the present invention advantageously possesses a glass transition temperature of at least 210° C., preferably 220° C., more preferably at least 230° C.

Glass transition temperature (Tg) is generally determined by DSC, according to ASTM D3418.

The (t-PAES) polymer of the present invention advantageously possesses a melting temperature of at least 330° C., preferably 340° C., more preferably at least 350° C. The (t-PAES) polymer of the present invention advantageously possesses a melting temperature below 430° C., preferably below 420° C. and more preferably below 410° C.

The melting temperature (Tm) is generally determined by DSC, according to ASTM D3418.

It is known that the crystallinity of polymers is characterized by their degree of crystallinity.

The degree of crystallinity can be determined by different methods known in the art such as notably by Wide Angle X-Ray diffraction (WAXD) and Differential Scanning calorimetry (DSC).

The Applicant has found that the (t-PAES) polymer, as detailed above, is especially well suited for providing chemical processing articles having a very high crystallinity.

The degree of crystallinity can advantageously be measured by DSC on compression molded samples of the (t-PAES) polymers of the present invention.

According to the present invention, molded parts of the (t-PAES) polymer have advantageously a degree of crystallinity above 5%, preferably above 7% and more preferably above 8%.

The manufacturing of the (t-PAES) polymer of the present invention is not particularly limited. The (t-PAES) polymer can be prepared as notably described in EP 0 383 600 A2 or as notably described in our copending U.S. Provisional Patent Application.

The Applicant has found that the (t-PAES) polymer, as detailed above, is especially well suited for providing chemical processing articles having (1) high Tg and Tm for thermal performance, (2) high chemical resistance to harsh chemicals including notably sulfuric acid, (3) resistance to rapid decompression and are of (4) thermoplastic nature.

t-(PAES) Polymeric Material

The (t-PAES) polymeric material may comprise (t-PAES) polymer in a weight amount of at least 10%, at least 30%, at least 40% or at least 50%, based on the total weight of the (t-PAES) polymeric material. Preferably, the (t-PAES) polymeric material comprises (t-PAES) polymer in a weight amount of at least 70%, based on the total weight of the (t-PAES) polymeric material. More preferably, the (t-PAES) polymeric material comprises the (t-PAES) polymer in a weight amount of at least 90%, if not at least 95%, based on the total weight of the (t-PAES) polymeric material. Still more preferably, the (t-PAES) polymeric material consists essentially of the (t-PAES) polymer. The most preferably, it consists essentially of the (t-PAES) polymer.

For the purpose of the present invention, the expression “consisting essentially of” is to be understood to mean that any additional component different from the (t-PAES) polymer, as detailed above, is present in an amount of at most 1% by weight, based on the total weight of the composition (C), so as not to substantially alter advantageous properties of the composition.

The (t-PAES) polymeric material may further optionally comprise one or more than one additional ingredient (I) generally selected from the group consisting of (i) colorants such as notably a dye (ii) pigments such as notably titanium dioxide, zinc sulfide and zinc oxide (iii) light stabilizers, e.g. UV stabilizers (iv) heat stabilizers (v) antioxidants such as notably organic phosphites and phosphonites, (vi) acid scavengers (vii) processing aids (viii) nucleating agents (ix) internal lubricants and/or external lubricants (x) flame retardants (xi) smoke-suppressing agents (x) anti-static agents (xi) anti-blocking agents (xii) conductivity additives such as notably carbon black and carbon nanofibrils (xiii) plasticizers (xiv) flow modifiers (xv) extenders (xvi) metal deactivators and combinations comprising one or more of the foregoing additives.

When one or more than one additional ingredient (I) are present, their total weight, based on the total weight of polymer composition (C), is usually below 20%, preferably below 10%, more preferably below 5% and even more preferably below 2%.

If desired, the (t-PAES) polymeric material comprises more than 80 wt. % of the (t-PAES) polymer with the proviso that the (t-PAES) polymer is the only polymeric component in the (t-PAES) polymeric material and one or more than one additional ingredient (I) might be present therein, without these components dramatically affecting relevant mechanical and toughness properties of (t-PAES) polymeric material.

The expression ‘polymeric components’ is to be understood according to its usual meaning, i.e. encompassing compounds characterized by repeated linked units, having typically a molecular weight of 2 000 or more.

The (t-PAES) polymeric material may further comprise at least one reinforcing filler. Reinforcing fillers are well known by the skilled in the art. They are preferably selected from fibrous and particulate fillers different from the pigment as defined above. More preferably, the reinforcing filler is selected from mineral fillers (such as talc, mica, kaolin, calcium carbonate, calcium silicate, magnesium carbonate), glass fiber, carbon fibers, synthetic polymeric fiber, aramid fiber, aluminum fiber, titanium fiber, magnesium fiber, boron carbide fibers, rock wool fiber, steel fiber, wollastonite etc. Still more preferably, it is selected from mica, kaolin, calcium silicate, magnesium carbonate, glass fiber, carbon fibers and wollastonite etc.

Preferably, the filler is chosen from fibrous fillers. A particular class of fibrous fillers consists of whiskers, i.e. single crystal fibers made from various raw materials, such as Al₂O₃, SiC, BC, Fe and Ni.

In one embodiment of the present invention the reinforcing filler is chosen from wollastonite and glass fiber. Among fibrous fillers, glass fibers are preferred; they include chopped strand A-, E-, C-, D-, S-, T- and R-glass fibers, as described in chapter 5.2.3, p. 43-48 of Additives for Plastics Handbook, 2^{nd} edition, John Murphy.

Glass fibers optionally comprised in polymer (t-PAES) polymeric material may have a circular cross-section or a non-circular cross-section (such as an oval or rectangular cross-section).

When the glass fibers used have a circular cross-section, they preferably have an average glass fiber diameter of 3 to 30 μm and particularly preferred of 5 to 12 μm. Different sorts of glass fibers with a circular cross-section are available on the market depending on the type of the glass they are made of One may notably cite glass fibers made from E- or S-glass.

Good results were obtained with standard E-glass material with a non-circular cross section. Excellent results were obtained when the polymer composition with S-glass fibers with a round cross-section and, in particular, when using round cross-section with a 6 μm diameter (E-Glass or S-glass).

In another embodiment of the present invention the reinforcing filler is a carbon fiber.

As used herein, the term “carbon fiber” is intended to include graphitized, partially graphitized and ungraphitized carbon reinforcing fibers or a mixture thereof. Carbon fibers useful for the present invention can advantageously be obtained by heat treatment and pyrolysis of different polymer precursors such as, for example, rayon, polyacrylonitrile (PAN), aromatic polyamide or phenolic resin; carbon fibers useful for the present invention may also be obtained from pitchy materials. The term “graphite fiber” intends to denote carbon fibers obtained by high temperature pyrolysis (over 2000° C.) of carbon fibers, wherein the carbon atoms place in a way similar to the graphite structure. Carbon fibers useful for the present invention are preferably chosen from the group composed of PAN-based carbon fibers, pitch based carbon fibers, graphite fibers, and mixtures thereof.

The weight of said reinforcing filler is advantageously preferably below 60% wt., more preferably below 50% wt., even more preferably below 45% wt., most preferably below 35% wt., based on the total weight of the (t-PAES) polymeric material.

Preferably, the reinforcing filler is present in an amount ranging from 10 to 60% wt., preferably from 20 to 50% wt., preferably from 25 to 45% wt., most preferably from 25 to 35% wt., based on the total weight of the polymer (t-PAES) polymeric material.

The (t-PAES) polymeric material can be prepared by a variety of methods involving intimate admixing of the at least one (t-PAES) polymer, optionally the reinforcing filler and optionally additional ingredient (I) desired in the polymeric material, for example by dry blending, suspension or slurry mixing, solution mixing, melt mixing or a combination of dry blending and melt mixing.

Typically, the dry blending of (t-PAES) polymer, as detailed above, preferably in powder state, optionally additional ingredient (I) the reinforcing filler and optionally is carried out by using high intensity mixers, such as notably Henschel-type mixers and ribbon mixers so as to obtain a physical mixture, in particular a powder mixture of the at least one (t-PAES) polymer, optionally the reinforcing filler and optionally additional ingredient (I).

Alternatively, the intimate admixing of the at least one (t-PAES) polymer, optionally the reinforcing filler and optionally additional ingredient (I) desired in the polymeric material, is carried out by tumble blending based on a single axis or multi-axis rotating mechanism so as to obtain a physical mixture. Alternatively, the slurry mixing of the (t-PAES) polymer, as detailed above optionally the reinforcing filler and optionally additional ingredient (I) is carried out by first slurrying said (t-PAES) polymer in powder form with optionally the polymers (T), optionally the reinforcing filler and optionally additional ingredient (I) using an agitator in an appropriate liquid such as for example methanol, followed by filtering the liquid away, so as to obtain a powder mixture of the at least one (t-PAES) polymer, optionally the reinforcing filler and optionally additional ingredient (I).

In another embodiment, the solution mixing of the (t-PAES) polymer, as detailed above, optionally the reinforcing filler and optionally additional ingredient (I) is carried out by dissolving said (t-PAES) polymer in powder form with optionally the polymers (T), optionally the reinforcing filler and optionally additional ingredient (I) using an agitator in an appropriate solvent or solvent blends such as for example diphenyl sulfone, benzophenone, 4-chlorophenol, 2-chlorophenol, meta-cresol. Diphenyl sulfone and 4-chlorophenol are most preferred.

Following the physical mixing step by one of the aforementioned techniques, the physical mixture, in particular the obtained powder mixture, of the at least one (t-PAES) polymer, optionally the reinforcing filler and optionally additional ingredient (I) is typically melt fabricated by known methods in the art including notably melt fabrication processes such as compression molding, injection molding, extrusion and the like, to provide the above described part of chemical processing article or a finished chemical processing article.

So obtained physical mixture, in particular the obtained powder mixture can comprise the (t-PAES) polymer, as detailed above, the reinforcing filler, as detailed above, and optionally, other ingredients (I) in the weight ratios as above detailed, or can be a concentrated mixture to be used as masterbatch and diluted in further amounts of the (t-PAES) polymer, as detailed above, the reinforcing filler, as detailed above, and optionally, other ingredients (I) in subsequent processing steps. For example, the obtained physical mixture can be extruded into a stock shape like a slab or rod from which a final part can be machined. Alternatively, the physical mixture can be compression molded into a finished part of the chemical processing article or into a stock shape from which a finished part of the chemical processing article can be machined.

It is also possible to manufacture the composition of the invention by further melt compounding the powder mixture as above described. As said, melt compounding can be effected on the powder mixture as above detailed, or directly on the (t-PAES) polymer, as detailed above, the reinforcing filler, as detailed above, and optionally, other ingredients (I). Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used.

If desired, the design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients. Provided that optimum mixing is achieved between the bulk polymer and filler contents. It is advantageously possible to obtain strand extrudates which are not ductile of the (t-PAES) polymeric material of the invention. Such strand extrudates can be chopped by means e.g. of a rotating cutting knife after some cooling time on a conveyer with water spray. Thus, for example (t-PAES) polymeric material which may be present in the form of pellets or beads can then be further used for the manufacture of the above described part of the chemical processing article.

Another objective of the present invention is to provide a method for the manufacture of the above described part of the chemical processing article. Such method is not specifically limited. The (t-PAES) polymeric material may be generally processed by injection molding, extrusion or other shaping technologies.

In one embodiment of the present invention, the method for the manufacture of the above described part of the chemical processing article or chemical processing article includes the step of injection molding and solidification of the polymer (t-PAES) polymeric material.

In another embodiment, the method for the manufacture of the above described part of the chemical processing article or chemical processing article includes the step of coating.

For example, the (t-PAES) polymeric material can be applied to a wire as a coating by using any suitable coating method, preferably by extrusion coating around a wire to form a coated wire, such as notably disclosed in U.S. Pat. No. 4,588,546.

Techniques for manufacturing wire coatings are well known in the art.

In another embodiment of the present invention, the method for the manufacture of the above described part of the chemical processing article or the finished chemical processing article, as described above includes the machining of a standard shaped structural part in a part having any type of size and shape. Non limiting examples of said standard shaped structural part include notably a plate, a rod, a slab and the like. Said standard shaped structural parts can be obtained by extrusion or injection molding of the polymer (t-PAES) polymeric material.

The Applicant has now found that said chemical processing article parts and finished chemical processing article comprising the (t-PAES) polymeric material of the present invention have (1) high Tg and Tm for thermal performance, (2) high chemical resistance to chemicals important to the CPI including sulfuric acid, (3) resistance to rapid decompression and (4) thermoplastic nature. Thus said articles can be employed successfully in the CPI manufacturing activities requiring the above mentioned severe operating conditions of high temperature, high pressure, harsh chemicals and other extreme conditions while at the same time having a more cost effective article fabrication.

Should the disclosure of any patents, patent applications, and publications which are incorporated herein by reference conflict with the description of the present application to the extent that it may render a term unclear, the present description shall take precedence.

The invention will be now described in more details with reference to the following examples, whose purpose is merely illustrative and not intended to limit the scope of the invention.

### Raw Materials

1,1′:4′,1″-terphenyl-4,4″-diol commercially available from Yonghi Chemicals, China, further purified by washing with ethanol/water (90/10) at reflux. The purity of the resulting material was shown to be higher than 94.0% area as measured by Gas Chromatography, as detailed below.

4,4′-difluorodiphenylsulfone commercially available from Aldrich (99% grade, 99.32% measured) or from Marshallton (99.92% pure by GC).

Diphenyl sulfone (polymer grade) commercially available from Proviron (99.8% pure).

Potassium carbonate with a d₉₀<45 μm commercially available from Armand products.

Lithium chloride (99+%, ACS grade) commercially available from Acros.

KetaSpire® KT-820 NT, a PEEK (Polyetheretherketone) fine powder with a maximum particle size defined by 100% passage through a 100 mesh screen and a melt viscosity at 400° C. and 1000 s⁻¹ using ASTM D3835 in the range 0.38-0.50 kPa·s; commercially available from SOLVAY SPECIALTY POLYMERS USA, LLC.

General Procedure for the Preparation of the t-PAES Polymer—Examples 1 and 2

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 89.25 g of diphenyl sulfone, 28.853 g of a specific type of 1,1′:4′,1″-terphenyl-4,4″-diol and 27.968 g of 4,4′-difluorodiphenylsulfone (corresponding to a total % monomers of 38,9% and molar ratio dihalo (BB)/diol of 1.000). The flask content was evacuated under vacuum and then filled with high purity nitrogen (containing less than 10 ppm O₂). The reaction mixture was then placed under a constant nitrogen purge (60 mL/min). The reaction mixture was heated slowly to 220° C. At 220° C., 15.354 g of K₂CO₃ were added via a powder dispenser to the reaction mixture over 30 minutes. At the end of the addition, the reaction mixture was heated to 320° C. at 1° C./minute. After 13 minutes at 320° C., 1.119 g of 4,4′-difluorodiphenylsulfone were added to the reaction mixture while keeping a nitrogen purge on the reactor. After 2 minutes, 4.663 g of lithium chloride were added to the reaction mixture. 2 minutes later, another 0.280 g of 4,4′-difluorodiphenylsulfone were added to the reactor and the reaction mixture was kept at temperature for 5 minutes. The reactor content was then poured from the reactor into a stainless steel pan and cooled. The solid was broken up and ground in an attrition mill through a 2 mm screen. Diphenyl sulfone and salts were extracted from the mixture with acetone then water at pH between 1 and 12 then with acetone. The powder was then removed from the reactor and dried at 120° C. under vacuum for 12 hours yielding 44 g of a light brown powder. The powder was further ground subsequently in a lab-scale grinder to yield a fine powder with an average particle size of around 100 μm.

Examples 1 and 2 were prepared according to this general procedure. Except for example 2, 1.119 g of 4,4′-difluorodiphenylsulfone were added to the reaction mixture while keeping a nitrogen purge on the reactor after 27 minutes at 320° C. instead of after 13 minutes at 320° C.

The molecular weights of the final t-PAES polymer were measured by GPC, as detailed below and for example 1, Mₙ was found to be 39,000 g/mole and Mw was found to be 112,500 g/mole; for example 2, Mₙ was found to be 47,925 g/mole and Mw was found to be 97,036 g/mole, 29% crystallinity.

General Description of the Molding Process of a (t-PAES) Polymeric Material—Examples 1 and 2

The t-PAES polymer (example 1 or 2) or the PEEK fine powder polymer (comparative example 3) were compression molded into 4 in×4 in×0.125 in plaques using a Fontijne programmable compression molding press according to the compression molding protocols as shown in Table 1. The compression molded plaques of example 1 and comparative example 3 were next machined into Type V ASTM tensile specimens and 0.5 in wide flexural specimens and these specimens were subjected to tensile testing per ASTM method D638 and flexural testing by ASTM method D790 before and after exposure to pressure and chemical resistance simulated conditions, i.e. rapid gas depressurization as described in detail below, see in Table 3.

The compression molded plaques of example 2 and were machined into 2 in×0.5 in×0.125 in specimens. Said specimens were immersed in conc. Sulfuric acid at room temperature and their weight and aspect was checked every 24 h. The results after 240 h of immersion are summarized in Table 2

TABLE 1
t-PAES polymer (example 1)

| | Pressure | | Heat | Cooling |
|---|---|---|---|---|
| Segment | (lbf 10²) | Time (hh.mm.ss) | (° F.) | Control Contacts) |
| 1 | 45 | 0:15:00 | 790 | |
| 2 | 60 | 0:02:00 | 790 | |
| 3 | 60 | 0:20:00 | 610 | |
| 4 | 60 | 1:30:00 | 610 | |
| 5 | 45 | 1:10:00 | 75 | Set @00 00 00 00 1, |
| | | | | Water |

TABLE 2
swelling in conc. H₂SO₄

| | Examples | |
|---|---|---|
| | | Comparative |
| | Example 2 | Example 3 |
| % weight gain after 240 h | 1.2 | dissolved in <24 h |
| Surface aspect after 240 h | Surface smooth and | N/A sample |
| | shiny, not affected | dissolved |

N/A: not applicable

The results in Table 2 clearly demonstrate the superior resistance of the t-PAES polymer of the invention to oxidizing acids.

### The Following Characterizations Carried Out on the Materials of the Examples are Indicated Hereinafter

### Molecular Weight Measurements by a GPC Method

### GPC Condition:

Pump: 515 HPLC pump manufactured by Waters
Detector: UV 1050 series manufactured by HP
Software: Empower Pro manufactured by Waters
Injector: Waters 717 Plus Auto sampler
Flow rate: 0.5 ml/min
UV detection: 270 nm
Column temperature: 40° C.
Column: 2× PL Gel mixed D, 5 micron, 300 mm×7.5 mm 5 micron manufactured by Agilent
Injection: 20 μliter
Runtime: 60 minutes
Eluent: N-Methyl-2-pyrrolidone (Sigma-Aldrich, Chromasolv Plus for HPLC>99%) with 0.1 mol Lithium bromide (Fisher make). Mobile phase should be store under nitrogen or inert environment.
Calibration standard: Polystyrene standards part number PL2010-0300 manufactured by Agilent was used for calibration. Each vial contains a mixture of four narrow polydispersity polystyrene standards (a total 11 standard, 371100, 238700, 91800, 46500, 24600, 10110, 4910, 2590, 1570,780 used to establish calibration curve).
Concentration of standard: 1 milliliter of mobile phase added in to each vial before GPC injection for calibration.
Calibration Curve: 1) Type: Relative, Narrow Standard Calibration 2) Fit: 3^{rd} order regression
Integration and calculation: Empower Pro GPC software manufactured by Waters used to acquire data, calibration and molecular weight calculation. Peak integration start and end points are manually determined from significant difference on global baseline.
Sample Preparation: 25 mg of the (t-PAES) polymer was dissolved in 10 ml of 4-chlorophenol upon heating at 170 to 200° C. A small amount (0.2 to 0.4 ml) of said solution obtained was diluted with 4 ml of N-Methyl-2-pyrrolidone. The resulting solution was passed through to GPC column according to the GPC conditions mentioned above.

### Pressure and Chemical Resistance Simulated Conditions

### Rapid Gas Decompression Test

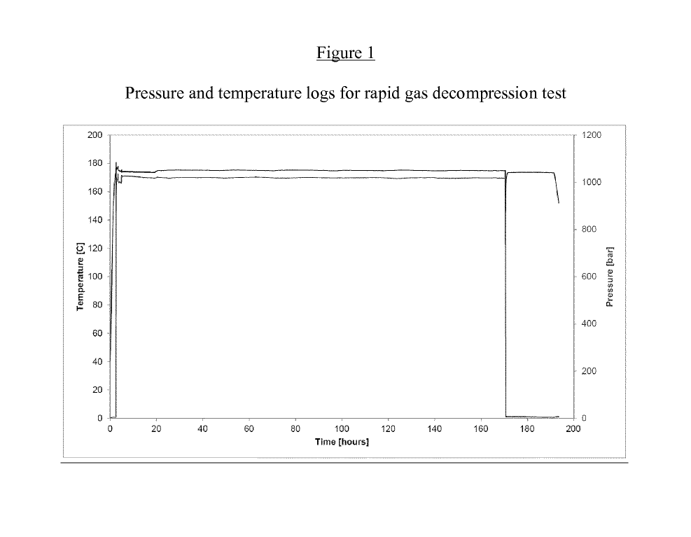

A rapid gas decompression (RGD) test was first conducted on flexural bar samples of the example 1 and comparative example 3. This test evaluates the ability of plastic materials to withstand rapid gas depressurization in chemicals processing environments. To perform this test, flexural molded specimens from Example 1 and from comparative example 3 were first placed into a pressure vessel and the vessel was sealed and heated to 175° C. A 90/10 by weight methane/CO₂ mixture was then introduced to the pressure vessel boosting the pressure in the vessel to 1000 bar (14500 psi). After one week maintained at these test pressure and temperature, the pressure was released from the vessel automatically at a controlled rate of 70 bar/minute. The pressure and temperature profile curves for this test are shown in FIG. 1. Following the exposure, the specimens of the example 1 and comparative example 3 were taken out of the pressure vessel and were subjected to weight and volume change measurements as well as to flexural property testing. The measurements were performed on five replicate specimens for each material and the results as shown in Table 3, are the average values for the five replicates. Appearance of the exposed specimens was observed visually and reported in Table 3.

TABLE 3
Mass and volume change and flexural properties upon exposure to the
rapid gas decompression test.

| | Examples | |
|---|---|---|
| | | Comparative |
| | Example 1 | Example 3 |
| Mass Change (%) | −0.3 | −0.19 |
| Volume Change (%) | 1.8 | 0.2 |
| Mechanical properties | | |
| Flex Strength Not | 14500 | 21000 |
| Exposed (psi) | | |
| Flex Strength (psi) | 14600 | 22600 |
| Flex Strength Change | +0.7 | +7.6 |
| (%) | | |
| Flex Modulus Not | 372 | 559 |
| Exposed (ksi) | | |
| Flex Modulus (ksi) | 356 | 572 |
| Flex Modulus Change | −4.3 | +2.3 |
| (%) | | |
| Surface properties | | |
| Appearance of Flex | 1 out of 5 bars has 3 very | 2 out of of 5 bars are |
| Bars after Exposure | small blisters | heavily blisters |

### Hot Oil Exposure Test

A hot oil exposure test was conducted using the ASTM tensile test specimens from the example 1 and comparative example 3, as described above. The hot oil exposure test was undertaken at the prevailing vapor pressure in a pressure cell equipped with an external heater band, thermocouple and calibrated pressure sensor. Pressure and temperature were logged by a PC running dedicated software. Specimens were exposed in the high pressure cell at a temperature of 270° C. and vapor pressure for a duration of 3 days after which the specimens were taken out and measured for weight change and dimensional change and then returned for an additional exposure time of 3 days at the same conditions. At the conclusion of the second 3 days of exposure, the test specimens were taken out for the final time and weight and dimensional changes were measured and logged and additionally tensile testing was conducted on the exposed specimens to determine if there has been any downgrade in mechanical performance as a result of the high pressure and high temperature oil exposure. Weight and volume change results as well as tensile properties before and after exposure are reported in Table 4.

TABLE 4
Mass and volume change and tensile properties upon 6 days of exposure
to the hot oil test.

| | Examples | |
|---|---|---|
| | | Comparative |
| | Example 1 | Example 3 |
| Mass Change (%) | +3.0 | +3.5 |
| Volume Change (%) | +3.1 | +3.7 |
| Mechanical properties | | |
| Tensile Strength Not Exposed (psi) | 12000 | 13000 |
| Tensile Strength Exposed (psi) | 12600 | 13900 |
| Tensile Strength Change (%) | +5.0 | +6.9 |
| Tensile Modulus Not Exposed (ksi) | 414 | 551 |
| Tensile Modulus Exposed (ksi) | 458 | 639 |
| Tensile Modulus Change (%) | +10.6 | +16.0 |
| Tensile Elong. at Break Not | 14.0 | 79 |
| Exposed (%) | | |
| Tensile Elongation at Break | 9.8 | 37 |
| Exposed (%) | | |
| Tensile Elongation at Break Change | −30 | −53 |
| (%) | | |
| Surface properties | | |
| Appearance of Flex Bars after | No Change | No Change |
| Exposure | | |

1-15. (canceled)

16. A chemical processing article comprising a poly(arylether sulfone) polymeric material, (t-PAES) polymeric material, comprising at least one poly(arylether sulfone) polymer, (t-PAES) polymer, wherein said (t-PAES) polymer comprises more than 50% moles of recurring units (Rₜ) of formula (Sₜ):
-E-Ar¹—SO₂—[Ar²-(T-Ar³)ₙ—SO₂]ₘ—Ar⁴— (formula Sₜ)
wherein:
n and m, equal to or different from each other, are independently zero or an integer of 1 to 5;
each of Ar¹, Ar², Ar³ and Ar⁴ equal to or different from each other and at each occurrence, is an aromatic moiety;
T is a bond or a divalent group optionally comprising one or more than one heteroatom;
E is of formula (Eₜ): 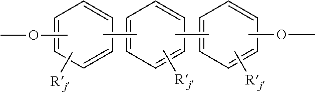
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium; and
j′ is zero or is an integer from 1 to 4.

17. The chemical processing article according to claim 16, wherein said recurring units (Rₜ) are selected from the group consisting of those of formula (Sₜ-1) to (Sₜ-4): 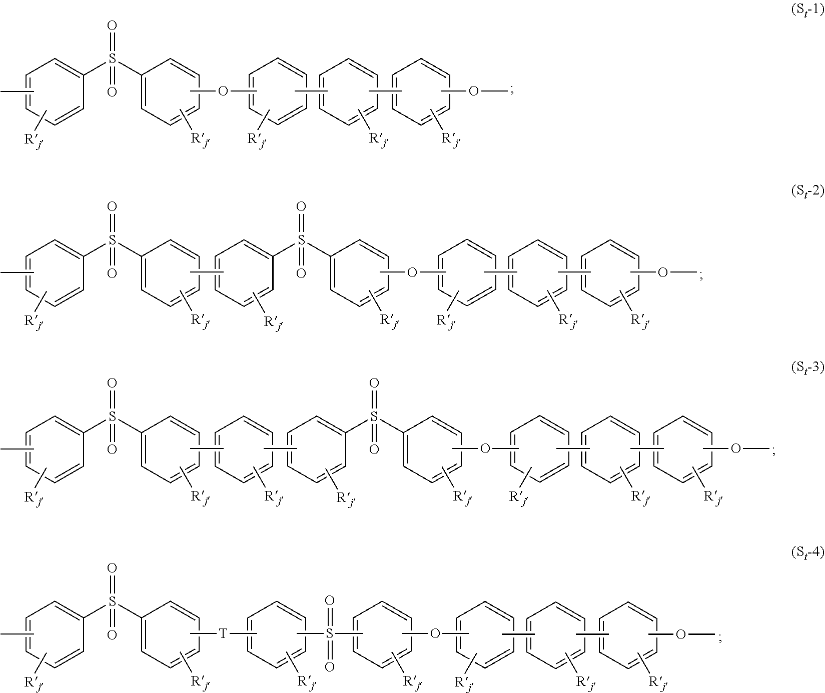
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 1 to 4; and
T is a bond or a divalent group optionally comprising one or more than one heteroatom.

18. The chemical processing article according to claim 16, wherein the (t-PAES) polymeric material further comprises one or more than one additional ingredient (I) different from the (t-PAES) polymer.

19. The chemical processing article according to claim 16, wherein the (t-PAES) polymeric material further comprises at least one reinforcing filler.

20. The chemical processing article according to claim 16, wherein said chemical processing article is an air separation system, a compressor system, a chemical processing pumping system, a motor system, a sensor, a control system, an agitator system, a centrifuge system, a chiller, a column, a reactor, a condenser, a converter, a cooler, a crystallizer, a dryer, an evaporator, an extruder, a conveyor, a heat exchanger, a fractionator, a furnace; a heater, a melt tank, a vessel, a precipitator, a reboiler, a reformer, a refrigeration system, a saturator, a scrubber, a silo, a tower, a waste heat boiler, a piping system, a valve system, or a tubing system.

21. The chemical processing article according to claim 20, wherein the pipe system is a pipe, a flexible riser, a pipe-in-pipe, a pipe liner, a jumper, or a spool.

22. The chemical processing article according to claim 16, wherein said article is a seal, a fastener, a cable, an electrical connector, or chemical processing housing.

23. The chemical processing article according to claim 22, wherein said seal is suitable for use in pumps, agitators, compressors, fittings, flanges, pipes, and ducts carrying gases, liquids, or both.

24. The chemical processing article according to claim 22, wherein the seal is a seal ring.

25. The chemical processing article according to claim 16, wherein said article is a coating.

26. A method for manufacturing a part of the chemical processing article according to claim 16, comprising a step of injection molding, extruding, or other shaping technologies, the (t-PAES) polymeric material.

27. The method for manufacturing a part of the chemical processing article according to claim 26, comprising the step of injection molding and solidifying the (t-PAES) polymeric material.

28. A method for manufacturing a part of the chemical processing article according to claim 16, comprising a step of coating the (t-PAES) polymeric material.

29. A method for processing at least one chemical, in which the method comprises at least one chemical processing article according to claim 16.

30. The method of claim 29, wherein said method is selected from the group consisting of:
(i) controlling air pollution,
(ii) treating industrial water solutions,
(iii) separating at least one gas,
(iv) filtrating at least one gas;
(v) transporting at least one fluid;
(vi) compressing at least one fluid;
(vii) reacting at least one chemical; and
(viii) heating or cooling at least one chemical.

31. The chemical processing article according to claim 16, wherein T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

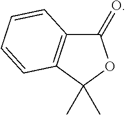

32. The chemical processing article according to claim 21, wherein the pipe system is a pipe, a flexible riser, or a pipe liner.

33. The chemical processing article according to claim 25, wherein the coating is a wire coating.

34. The method of claim 28, wherein the step of coating is extrusion coating.
